(19) United States
(12) Patent Application Publication
(10) Pub. No.: US 2007/0287446 A1
(43) Pub. Date: Dec. 13, 2007

(54) Methods and systems for monitoring a network

(76) Inventors: Juergen Voss, Wiesbaden (DE); Per Kangru, Fredriksberg (DK)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/449,492

(22) Filed: Jun. 8, 2006

(51) Int. Cl. H04Q 7/20

(52) U.S. Cl. 455/423

(57) ABSTRACT

Method and systems for monitoring a network.

### BACKGROUND

Many different cellular wireless technologies exist at the moment in parallel on the market. Users of wireless networks desire reliable roaming across disparate networks. Interoperability across the different technologies, for example, across UMTS, GSM, GPRS, WiMax and WiFi, and reliable roaming across technologies is a customer requirement.

There is a need for monitoring equipment that can verify interoperability and a seamless technology change across the different technologies.

### BRIEF DESCRIPTION OF THE DRAWINGS

For a better understanding of the present teachings, reference is made to the accompanying drawings and detailed description and its scope will be pointed out in the appended claims.

FIG. 1 is a schematic block diagram representation of an embodiment of the apparatus according to the present teachings;

FIG. 2 is a graphical depiction of an embodiment of the user interface according to the present teachings;

FIG. 3 is a schematic flowchart diagram representation of an embodiment of the method according to the present teachings; and

FIG. 4 is a graphical schematic representation of a block diagram of an embodiment of a component of an embodiment of the apparatus according to the present teachings.

### DETAILED DESCRIPTION

Embodiments according to the present teachings are now described more fully hereinafter with reference to the accompanying drawings. The following configuration description is presented for illustrative purposes only. Any computer configuration satisfying the speed and interface requirements herein described may be suitable for implementing the system of the present teachings.

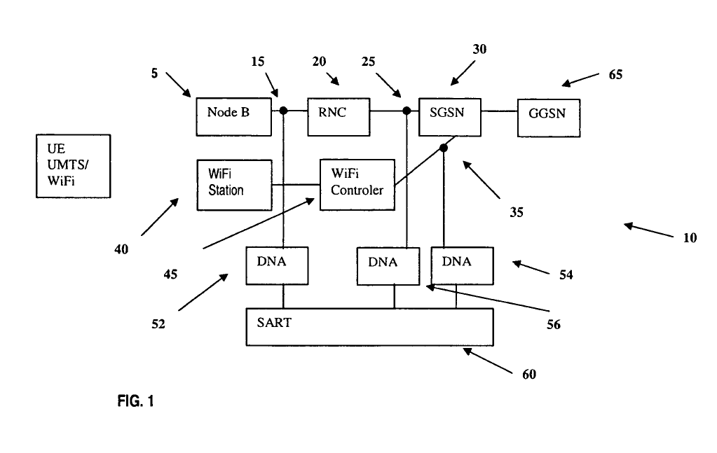

FIG. 1 is a block diagram representation of an embodiment of the apparatus according to the present teachings. In the configuration shown in FIG. 1, the technologies present are UMTS and WiFi, although the present teachings are not limited to this embodiment (WiFi is based on IEEE802.11. The embodiment shown in FIG. 1 also applies to WiMax, which is based on IEEE802.16). For example, embodiments in which the technologies include, but are not limited to, UMTS, GSM, GPRS, WiMax and WiFi, are within the scope of the present teachings. A description of UMTS and GPRS networks can be found in “Universal Mobile Telecommunications System (UMTS) Protocols and Protocol Testing”, available at http://www.iec.org/online/tutorials/umts/topic01.html?Back .x=12&Back.y=18 and in A. Gurtov et al., “Multi-Layer Protocol Tracing in a GPRS Network,” Proceedings of the IEEE Vehicular Technology Conference, Fall 2002, both of which are incorporated by reference herein. A description of GSM can be found in A. Dorman, The Essential Guide to Wireless Communication Applications, ISBN 0-13-031716-0, pp. 69-73, which are incorporated by reference herein. WiFi is described by the IEEE 802.11 group of standards, which are available at http://grouper.ieee.org/groups/802/11/. WiMax is described by the IEEE 802.16 group of standards, which are available at http://standards.ieee.org/getieee802/802.16.html.

Referring to FIG. 1, each Radio Access Networks (RAN) of the UMTS has a Radio Network Controller (RNC) 20 interfacing via Iub interfaces with one or more Node Bs 5. Node B 5, also known as a base station, provides radio interfaces or links to user equipment, for example a mobile terminal, outside the UMTS. Each Node B 5 provides radio coverage for the user equipments within a particular geographic region known as a cell. The RNC 20 manages the wireless radio interfaces of the Node Bs 5 and controls handoff, sending data from one of the core networks or to one or more Node Bs 5 in the forward direction, and selects the best signal from one or more Node Bs 5 and sends it to one of the core networks. In UMTS, GSM and GPRS networks are extended, and new services are integrated into an overall network that contains both existing interfaces, and new interfaces that include lu, interface between Node B 5 and RNC 20 (lub), and interface between two RNCs 20 (lur). The RNC has the following interfaces:
lu: RNC to GSM Phase 2+ CN interface (for example, to SGSN (serving GPRS support node) 30)
   lu-cs for circuit-switched data
   lu-ps for packet-switched data
lub: RNC to Node B interface
lur: RNC to RNC interface, not comparable to any interface in GSM.

In the configuration 10 shown in FIG. 1, a number of network analyzing systems 52, 54, 56 are operatively connected for capturing data at each of a number of interfaces in the network 15, 25, 35, at least one network analyzing system 52, 54, 56 capturing data at one interface 15, 25, 35.

At node 15, Node B 5 connects to the radio network controller, the RNC 20, through an appropriate interface (lub in one embodiment). At node 25, the RNC 20 connects to the SGSN 30 through an appropriate interface (lu-ps or lu-cs in one embodiment). A Wi-Fi station 40 connects through a Wi-Fi controller 45 to node 35. (In the WiMax embodiment, these are replaced by an Access Service Network, ASN, and a connectivity service network, CSN, connecting into the GGSN.) The connection may be, but is not limited to, a gateway or router, to the SGSN 30. A gateway GPRS support node, GGSN 65, is also shown, connected to the SGSN 30.

A signal analysis system 60 is connected so as to receive the captured data from the network analyzing systems 52, 54, 56 and is capable of analyzing the data. In analyzing the data, the signal analysis system 60 is capable of identifying data corresponding to one communication event and of combining the data identified as corresponding to that communication event. In one embodiment, that capability is established in software. In one instance, the software parses the received data according to the data fields in the standard or protocol. The network analyzer 52, 54, 56 provides an identifier or, in another instance, the data fields or data field structure identifies the technology. In parsing the data, the communication event is identified by data in one the fields. The software combines the data identified as corresponding to that communication event. A user interface (software) and a display provide the capability of displaying the data corresponding to that communication event.

The network analyzing systems 52, 54, 56 may be, for example, Agilent™ J6801A distributed network analyzer (or any other Agilent™ network analyzer, such as the network analyzers described in Agilent™ publications 5988-4231EN and 5988-4176EN, both of which are incorporated by reference herein), which can be used for real time extraction of the signaling data and distribution of the signaling data. Further, Agilent™ network analyzer software, such as the J6840A, can be used for the parallel analysis of the signaling data. This enables the signaling data to be analyzed with respect to a call. While the network analyzing systems 52, 54, 56 are described, in one embodiment, using Agilent™ products, the present invention is not limited to use by Agilent™ products, as it is understood that other products and devices are available to capture signaling and user data from a communication interface.

The signal analysis system 60 may be a personal computer running Agilent™ signaling analyzer software, such as the J7326A real time signaling analyzer software or the Agilent™ J7326A Signaling Analyzer (described in 5988-0347EN or 5988-8334EN, both of which are incorporated by reference herein). While the signal analysis system 60 is described, in one embodiment, using Agilent™ products, the present invention is not limited to use by Agilent™ products, as it is understood that other products and devices are available to perform similar functions.

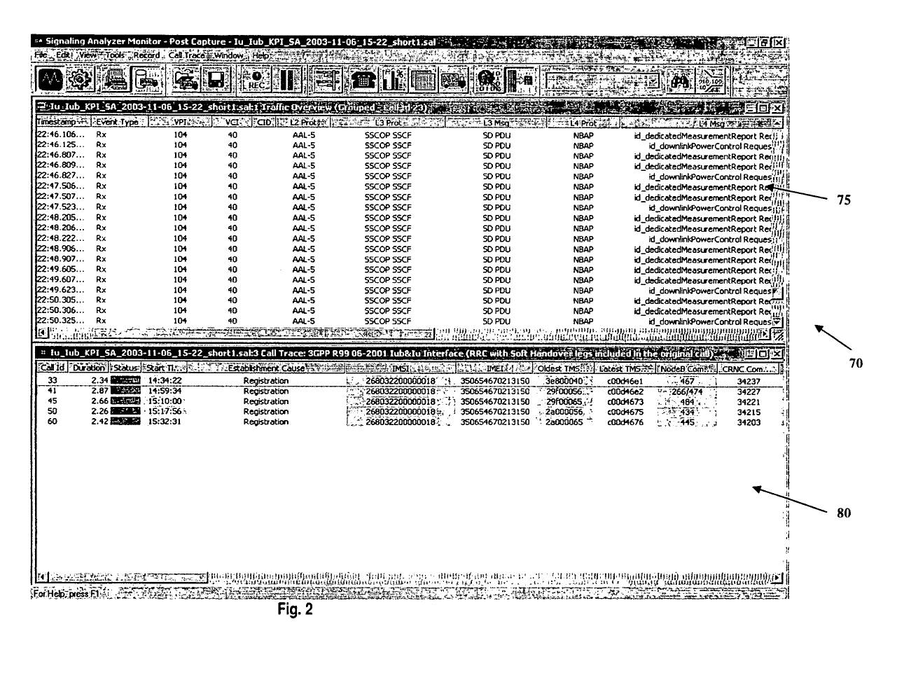

An embodiment of a user interface 70 of the signal analysis system 60 is shown in FIG. 2. The signal analysis system 60, by means of software in one embodiment, can reassemble the data, decode the different messages and display the results (chronologically) in a Traffic Overview window 75. Referring again to FIG. 2, characteristics 75 for a number of signaling messages) are displayed in a Call Trace window 80. Based on the decoded messages, the Call Trace combines messages relating to the same call together and showing key information of the call in the Call Trace window 80 as a line. In the case of the present teachings, the Call Trace combines both signaling streams and show call specific information in a UMTS/WiFi call trace or GSM/GPRS/WiFi call trace (or a UMTS/WiMax call trace or GSM/GPRS/WiMax call trace).

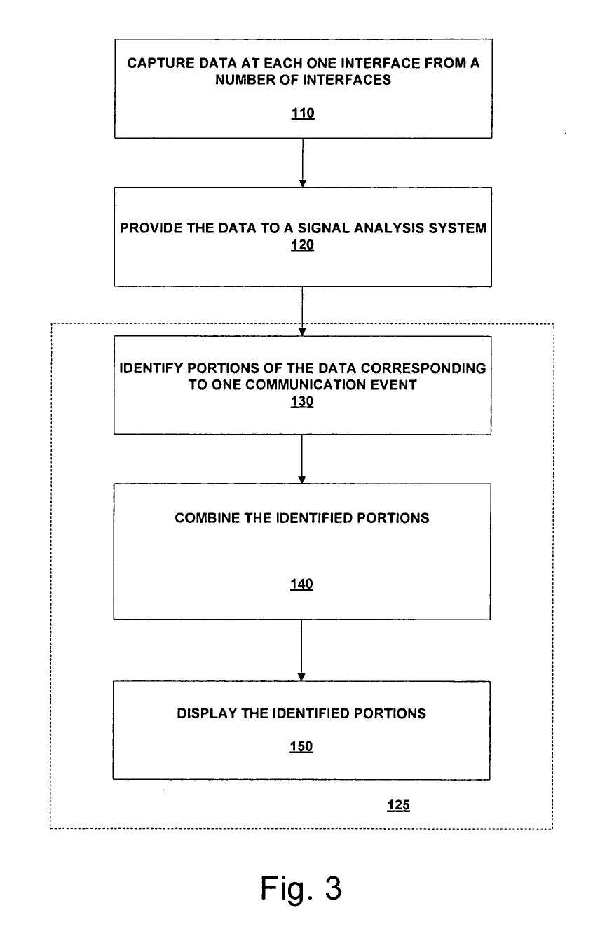

In one embodiment, utilizing the configuration of the present teachings, as shown in FIG. 3, the network 10 is monitored by capturing 110 data at each 15, 25, 35 in the network, each interface corresponding to one transmission technology from a number of transmission technologies, the data being captured via a number of network analyzing systems 52, 54, 56, providing 120 the data to a signal analysis system 60 and analyzing 125 the data. In one instance, analyzing 125 the data includes identifying 130 portions of the data corresponding to one communication event, combining 140 the portions of the data identified as corresponding to the communication event and displaying 150 the portions of the data identified as corresponding to the communication event.

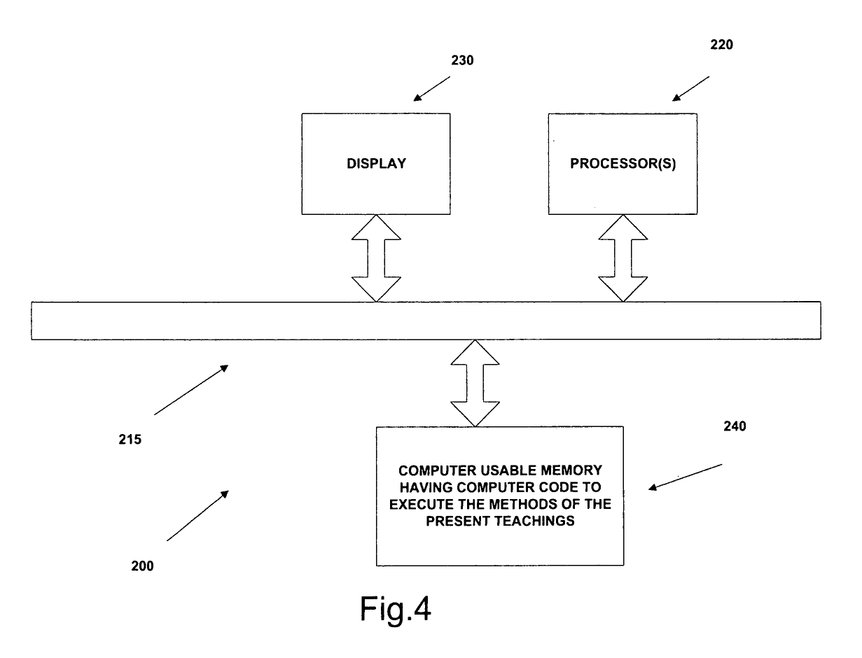

A block diagram representation of an embodiment 200 of the signal analysis system 60 is shown in FIG. 4. The embodiment 200 of the signal analysis system 60 shown in FIG. 4 includes one or more processors 220, a display device 230, and a computer usable medium (memory) 240. The computer usable memory 240 has computer readable code embodied therein that is capable of causing the one or more processors 220 to identify data corresponding to one communication event, combine the data identified as corresponding to the communication event, provide a user interface for depiction in the display device, the user interface enabling chronological display of the data identified as corresponding to the communication event and display of information corresponding to the communication event, and display, using the display device and upon user input, the data identified as corresponding to the communication event and information corresponding to the communication event.

The display 230, the one or more processors 220, and the computer usable medium 230 are operatively connected by means of a connection component 215 (the connection component may be, for example, a computer bus, or a carrier wave).

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method of the present teachings may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Other variations of the described teachings will occur to those skilled in the art given the benefit of the described teachings. The following claims define the scope of the invention.

1. A method for monitoring a network, the method comprising the steps of:
capturing data at each one interface from a plurality of interfaces in the network, each one interface from said plurality of interfaces corresponding to one transmission technology from a plurality of transmission technologies, said data being captured via a plurality of network analyzing systems;
providing said data to a signal analysis system; and
analyzing said data.

2. The method of claim 1 wherein the step of analyzing said data comprises the steps of:
identifying portions of said data corresponding to one communication event;
combining said portions of said data identified as corresponding to said one communication event.

3. The method of claim 2 wherein the step of analyzing said data further comprises the steps of:
displaying said portions of said data identified as corresponding to said one communication event.

4. The method of claim 1 wherein each technology from said plurality of transmission technologies is selected from the group consisting of UMTS, GSM, GPRS, WiMax and WiFi.

5. An apparatus for monitoring a network, the system comprising:
a plurality of network analyzing systems operatively connected for capturing data at each one interface of a plurality of interfaces in the network, at least one network analyzing system capturing data at one interface;
a signal analysis system connected to receive the captured data from said plurality of network analyzing systems and capable of analyzing the data.

6. The apparatus of claim 5 wherein said signal analysis system comprises:
means for identifying data corresponding to one communication event; and
means for combining the data identified as corresponding to said one communication event.

7. The apparatus of claim 6 wherein said signal analysis system further comprises:
means for displaying the data corresponding to said one communication event.

8. The apparatus of claim 5 wherein each technology from said plurality of transmission technologies is selected from the group consisting of UMTS, GSM, GPRS, WiMax and WiFi.

9. The apparatus of claim 5 wherein said signal analysis system comprises:
at least one processor;
a display device;
at least one computer usable medium having computer readable code embodied there in, said computer readable code being capable of causing said at least one processor to:
identify data corresponding to one communication event; and
combine the data identified as corresponding to said one communication event.
provide a user interface for depiction in the display device, the user interface enabling chronological display of the data identified as corresponding to said one communication event, and
display of information corresponding to said one communication event;
display, using the display device and upon user input, the data identified as corresponding to said one communication event and information corresponding to said one communication event.
